(19) United States
(12) Patent Application Publication
(10) Pub. No.: US 2015/0163848 A1
(43) Pub. Date: Jun. 11, 2015

(54) MULTI-CARRIER CONNECTION MANAGEMENT FOR BANDWIDTH AGGREGATION

(71) Applicant: QUALCOMM Incorporated, San Diego, CA (US)

(72) Inventors: Yih-Hao LIN, San Diego, CA (US); Ruoheng LIU, San Diego, CA (US); June NAMGOONG, San Diego, CA (US); Srikant JAYARAMAN, San Diego, CA (US)

(21) Appl. No.: 14/479,270

(22) Filed: Sep. 6, 2014

Related U.S. Application Data
(60) Provisional application No. 61/914,742, filed on Dec. 11, 2013.

(51) Int. Cl. H04W 76/04; H04B 7/185; H04W 72/04

(52) U.S. Cl. CPC H04W 76/046; H04W 72/0453; H04B 7/18506

(57) ABSTRACT

The connection management entity apparatus determines a set of modems within coverage of a particular area. Each modem of the set of modems is associated with a particular aircraft and one carrier of a plurality of carriers. The apparatus allocates subsets of modems to each eNB of a set of eNBs. The allocation allows each eNB to communicate with the allocated subset of modems. Each eNB operates on a different carrier. The apparatus may be a eNB. The eNB determines a set of modems within coverage of the eNB. The set of modems is associated with one carrier of a plurality of carriers. The eNB operates on the one carrier. Each modem in the set of modems is associated with a different aircraft. The eNB sends information indicating the set of modems and receives an allocation of a second set of modems in response to the sent information.

### CROSS-REFERENCE TO RELATED APPLICATION(S)

This application claims the benefit of U.S. Provisional Application Ser. No. 61/914,742, entitled “MULTI-CARRIER CONNECTION MANAGEMENT FOR BANDWIDTH AGGREGATION OVER LTE BEARERS” and filed on Dec. 11, 2013, which is expressly incorporated by reference herein in its entirety.

### BACKGROUND

1. Field

The present disclosure relates generally to communication systems, and more particularly, to multi-carrier connection management for bandwidth aggregation.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be a connection management entity. The apparatus determines a set of modems within coverage of a particular area. Each modem in the set of modems is associated with a particular aircraft and one carrier of a plurality of carriers. The apparatus allocates subsets of the set of modems to each cell of a set of cells. The allocation allows each cell to communicate with the allocated subset of modems. Each cell operates on a different carrier of the plurality of carriers.

In an aspect of the disclosure, a method, a computer program product, and an apparatus are provided. The apparatus may be a cell. The cell may be a base station or a cell within a base station. The base station may be an evolved Node B (eNB). The cell determines a set of modems within coverage of the cell. The set of modems is associated with one carrier of a plurality of carriers. The cell operates on the one carrier. Each modem in the set of modems is associated with a different aircraft. The cell sends information indicating the set of modems. The cell receives an allocation of a second set of modems in response to the sent information. The allocation allows the cell to communicate with the allocated second set of modems.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating a continuous carrier aggregation type.

FIG. 7B is a diagram illustrating a non-continuous carrier aggregation type.

FIG. 8 is a diagram illustrating a system framework for an air-ground mobile system.

FIG. 9 is a diagram illustrating a connection management entity within the system framework of FIG. 8.

FIG. 10 is a diagram illustrating an operation of the connection management entity.

FIG. 11 is a diagram illustrating an operation of the connection management entity and an associated eNB.

FIG. 12 is a flow chart illustrating exemplary methods for multi-carrier connection management for bandwidth aggregation over LTE bearers.

FIG. 13 is a diagram illustrating a first exemplary allocation method.

FIG. 14 is a diagram illustrating a second exemplary allocation method.

FIG. 15 is a flow chart of a first exemplary method of a connection management entity.

FIG. 16 is a flow chart of a second exemplary method of a cell.

FIG. 17 is a conceptual data flow diagram illustrating the data flow between different modules/means/components in an exemplary apparatus.

FIG. 18 is a diagram illustrating an example of a hardware implementation for an apparatus employing a processing system.

FIG. 19 is a conceptual data flow diagram illustrating the data flow between different modules/means/components in an exemplary apparatus.

FIG. 20 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

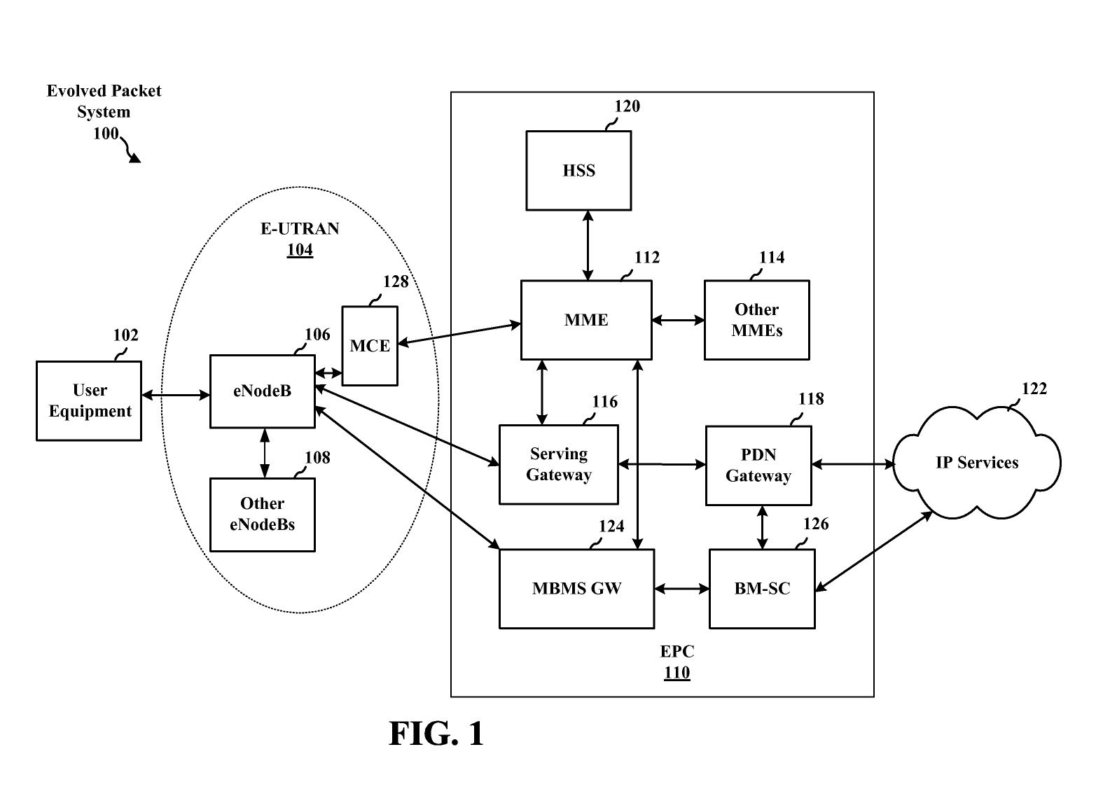

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the eNB 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

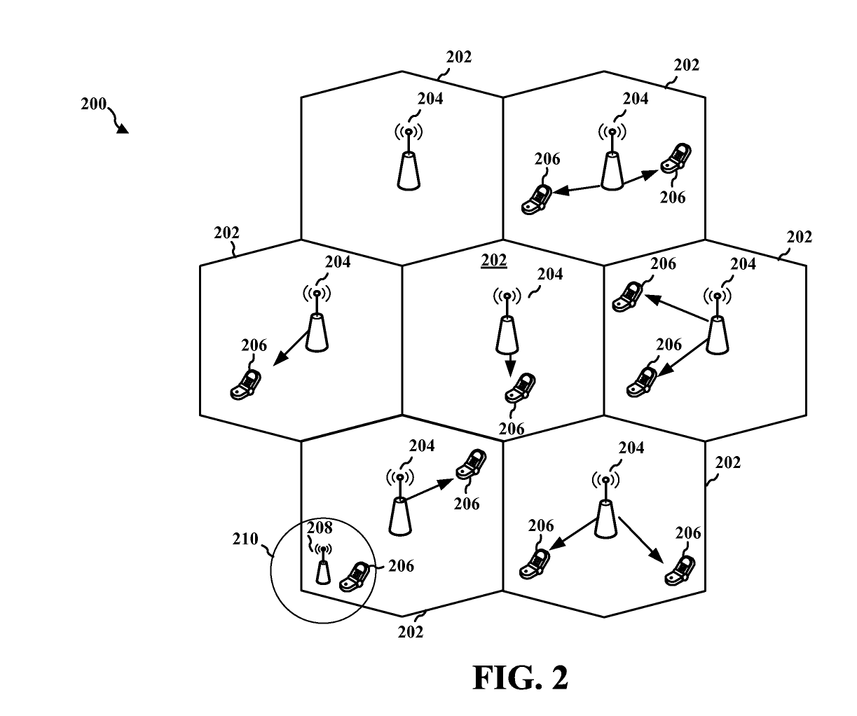

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). Macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

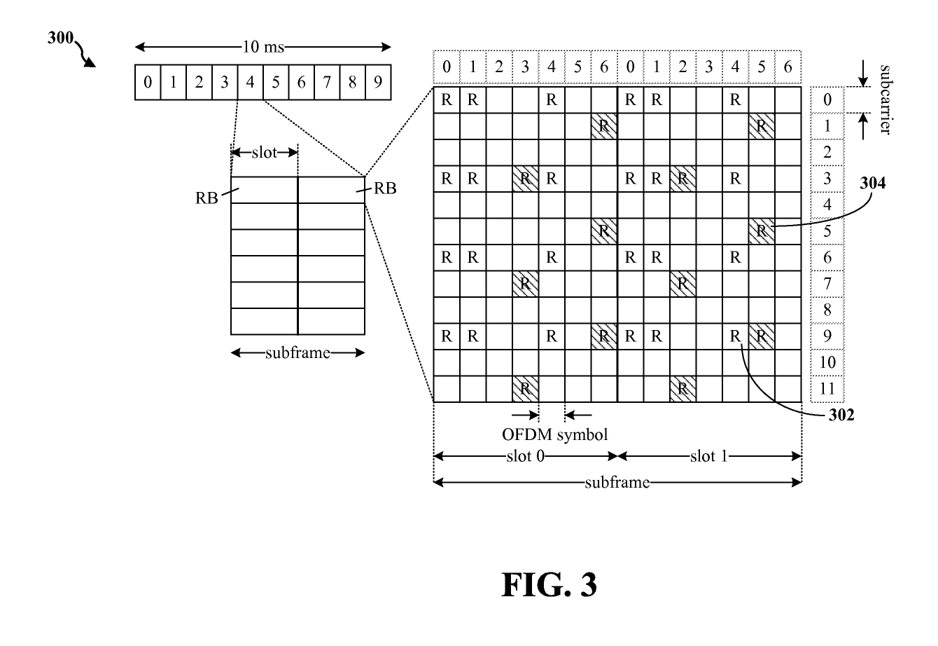

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block may contain 12 consecutive subcarriers in the frequency domain and, for a normal cyclic prefix in each OFDM symbol, 7 consecutive OFDM symbols in the time domain, or 84 resource elements. For an extended cyclic prefix, a resource block may contain 6 consecutive OFDM symbols in the time domain, or 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

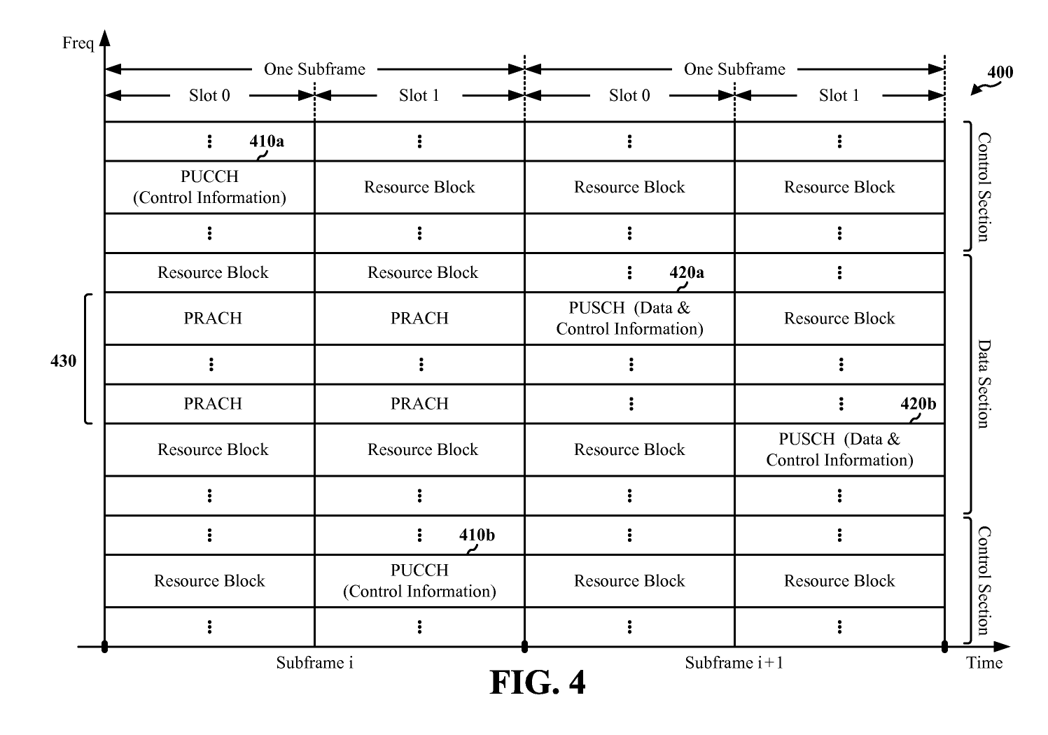

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

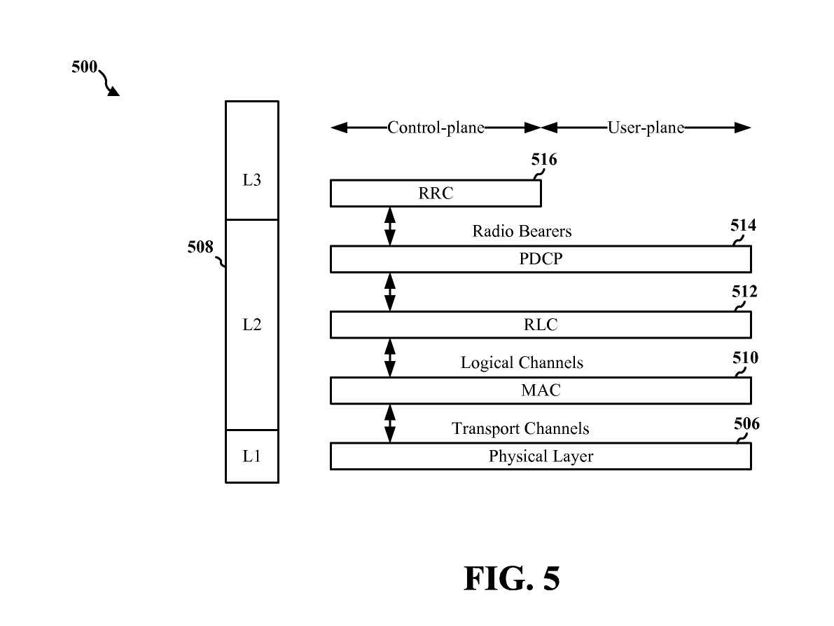

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

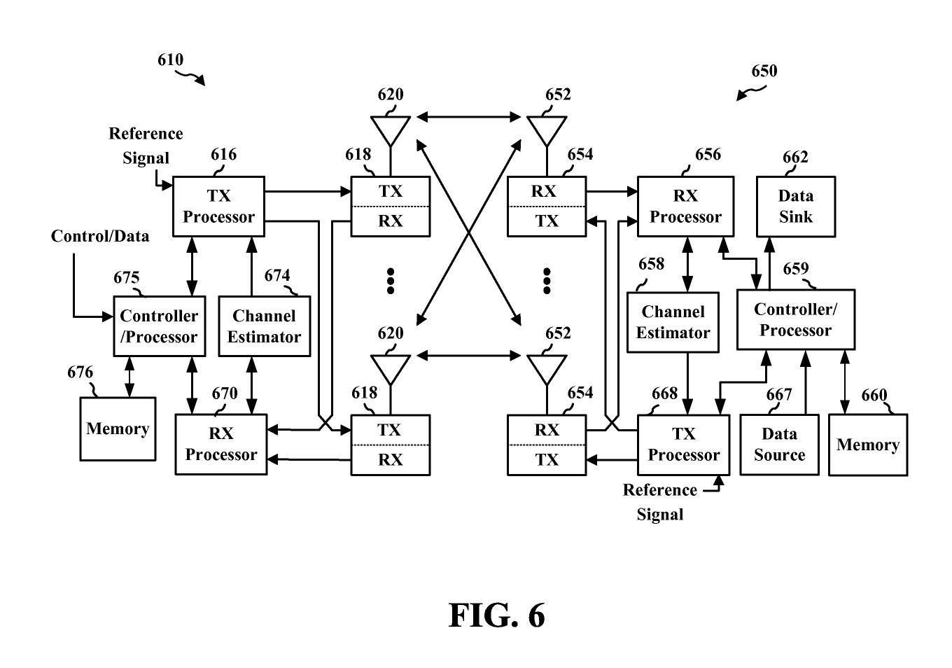

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each sub carrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

### Carrier Aggregation

UEs may use spectrum up to 20 MHz bandwidths allocated in a carrier aggregation of up to a total of 100 MHz (5 component carriers) used for transmission in each direction. Generally, less traffic is transmitted on the uplink than the downlink, so the uplink spectrum allocation may be smaller than the downlink allocation. For example, if 20 MHz is assigned to the uplink, the downlink may be assigned 100 Mhz. These asymmetric FDD assignments conserve spectrum and are a good fit for the typically asymmetric bandwidth utilization by broadband subscribers.

### Carrier Aggregation Types

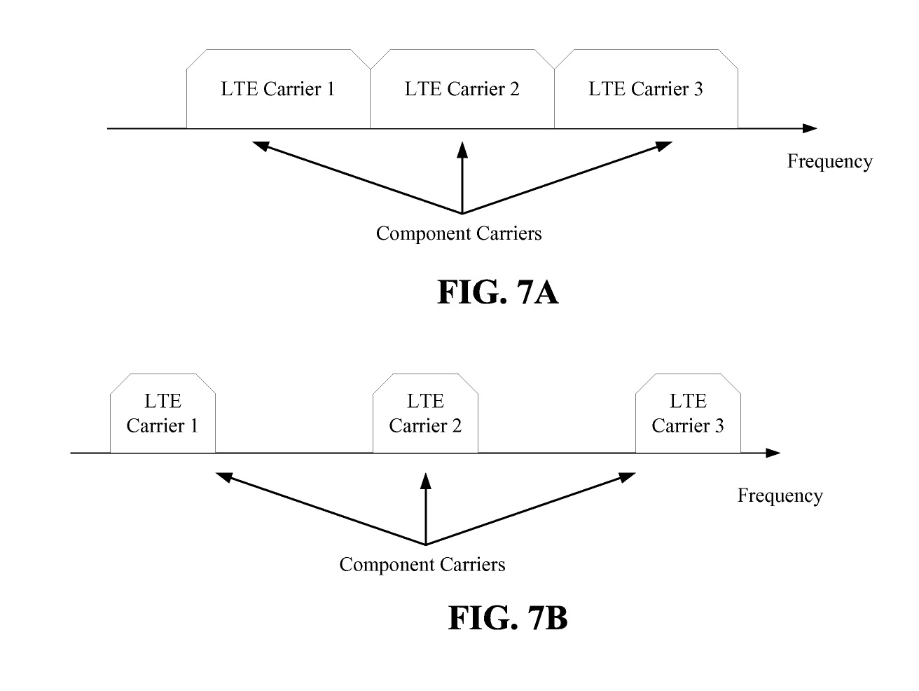

Two types of carrier aggregation (CA) methods have been proposed, continuous CA and non-continuous CA. The two types of CA methods are illustrated in FIGS. 7A and 7B. Non-continuous CA occurs when multiple available component carriers are separated along the frequency band (FIG. 7B). On the other hand, continuous CA occurs when multiple available component carriers are adjacent to each other (FIG. 7A). Both non-continuous and continuous CA aggregates multiple LTE/component carriers to serve a single UE.

Multiple RF receiving units and multiple FFTs may be deployed with non-continuous CA because the carriers are separated along the frequency band. Because non-continuous CA supports data transmissions over multiple separated carriers across a large frequency range, propagation path loss, Doppler shift, and other radio channel characteristics may vary a lot at different frequency bands.

Thus, to support broadband data transmission under the non-continuous CA approach, methods may be used to adaptively adjust coding, modulation, and transmission power for different component carriers. For example, where the eNB has fixed transmitting power on each component carrier, the effective coverage or supportable modulation and coding of each component carrier may be different.

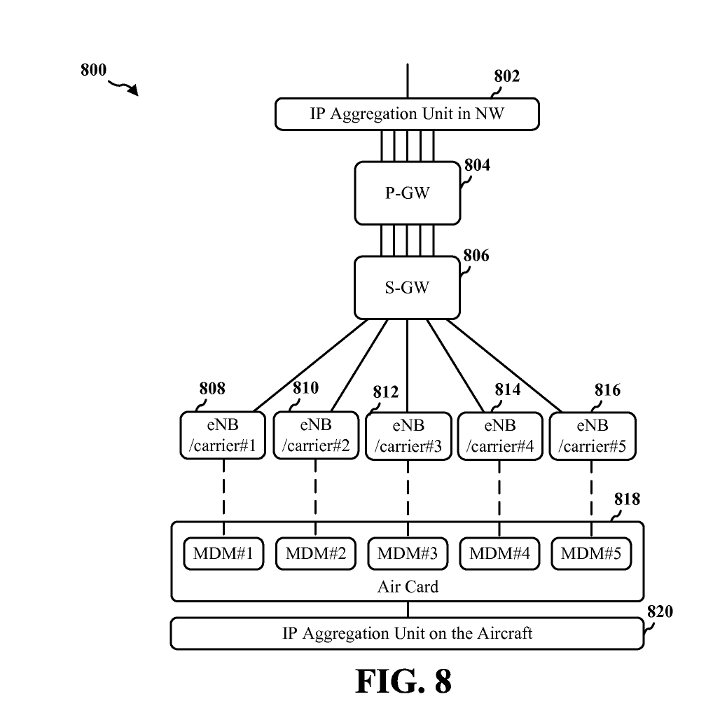

FIG. 8 is a diagram 800 illustrating a system framework for an air-ground mobile system. On the DL, a PDN Gateway (P-GW) 804 communicates with a Serving Gateway (S-GW) 806, which communicates with a plurality of eNBs 808, 810, 812, 814, 816. The eNBs are collocated together. Each of the eNBs 808-816 operates on different carrier frequencies. In one configuration, each eNB operates on 20 MHz spectrum, and together the eNBs 808-816 operate on 100 MHz spectrum through multiple carriers. Each of the eNBs 808-816 communicates with a corresponding mobile data modem (MDM) on an aircraft (air card) 818. The modems provide the received DL communication to an IP aggregation unit 820 on the aircraft. The IP aggregation unit 820 aggregates the DL communication and provides the aggregated DL communication to a local aircraft transceiver unit for transmission to the various UEs on the aircraft. On the UL, the local aircraft transceiver unit on the aircraft receives the UL communication from various UEs on the aircraft, and distributes the UL communication to the various modems. Each of the modems communicates with a corresponding eNB, which provides the received UL communication to the S-GW 806. The S-GW 806 provides the UL communication to the P-GW 804, which provides the UL communication to a Network (NW) IP aggregation unit 802. The NW IP aggregation unit 802 aggregates the UL communication.

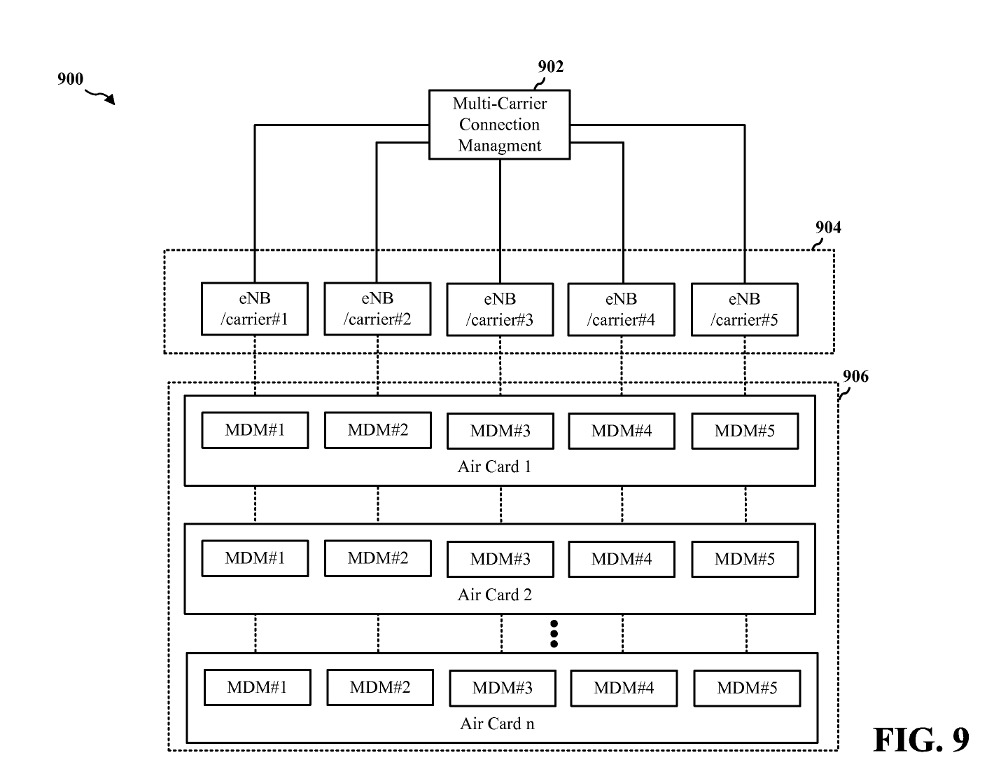

FIG. 9 is a diagram 900 illustrating a connection management entity within the system framework of FIG. 8. A multi-carrier connection management (MC-CM) entity 902 may coordinate communication between the modems 906 and the eNBs 904 for each of the carriers. Specifically, the MC-CM 902 may allocate modems to each eNB to allow the eNBs 904 to communicate with the modems 906. The MC-CM 902 may perform the coordination because of PDCCH loading constraints. Accordingly, while a set of modems may be within coverage of a particular eNB, the MC-CM 902 may allocate only a subset of the set of modems to the particular eNB in order to balance the load across the eNBs 904. For example, for the eNB operating on carrier#m, the MC-CM 902 may allocate only a subset of the set of modems MDM#m of the n air cards. When many aircraft are within a coverage area of the eNBs, the MC-CM 902 may drop some modems from communication with an eNB. When few aircraft are within a coverage area of the eNBs 904, the MC-CM 902 may add some modems for communication with an eNB. As such, UEs on a particular aircraft may operate with between 20 MHz of bandwidth and 100 MHz of bandwidth depending on how crowded the coverage area of the eNBs 904 is with aircraft. The MC-CM 902 effectively controls the bandwidth available to UEs on each aircraft based on the number of aircraft within the coverage area of the eNBs 904.

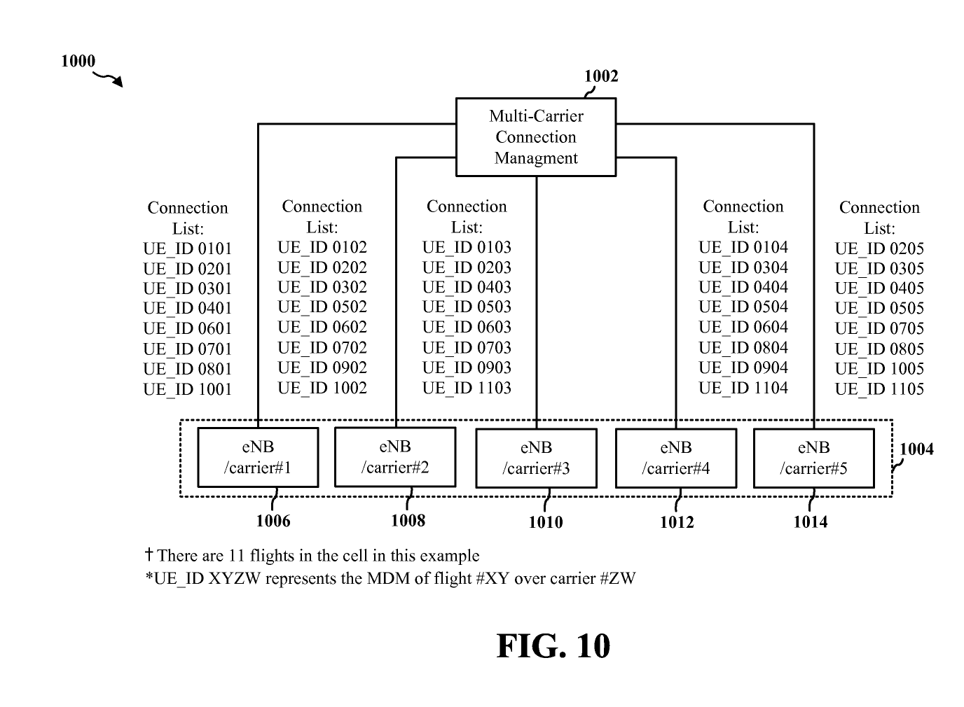

FIG. 10 is a diagram 1000 illustrating an operation of the connection management entity. The MC-CM 1002 manages the RRC/S1 connection across the carriers. The MC-CM 1002 forwards the list of modems, selected to work on the carrier, to the eNB of the eNBs 1004 operating on the carrier. The eNB determines the resource assignment in frequency (subband), time (subframes), and space (beam). As shown in FIG. 10, of 11 flights/aircraft, the MC-CM 1002 allocates a subset of flights to each eNB. In FIG. 10, a first eNB 1006 operating on carrier #1 communicates with the modems for carrier #1 on flights 1, 2, 3, 4, 6, 7, 8, and 10; a second eNB 1008 operating on carrier #2 communicates with the modems for carrier #2 on flights 1, 2, 3, 5, 6, 7, 9, and 10; a third eNB 1010 operating on carrier #3 communicates with the modems for carrier #3 on flights 1, 2, 4, 5, 6, 7, 9, and 11; a fourth eNB 1012 operating on carrier #4 communicates with the modems for carrier #4 on flights 1, 3, 4, 5, 6, 8, 9, and 11; and a fifth eNB 1014 operating on carrier #5 communicates with the modems for carrier #5 on flights 2, 3, 4, 5, 7, 8, 10, and 11.

The MC-CM 1002 determines a set of modems within coverage of a particular area. Each modem in the set of modems is associated with a particular aircraft and one carrier of a plurality of carriers. The MC-CM 1002 allocates subsets of the set of modems to each base station of a set of base stations 1004. The allocation allows each base station to communicate with the allocated subset of modems. Each base station operates on a different carrier of the plurality of carriers. For example, referring to FIG. 10, the MC-CM 1002 determines a set of modems within coverage of a particular area. The set of modems includes modems with the listed UE IDs 0101, 0102, 0103, . . . , 1105. Each modem in the set of modems is associated with a particular aircraft and one carrier of a plurality of carriers. For example, the modem with the UE_ID 0101 is associated with flight 1 and carrier #1. The MC-CM 1002 allocates subsets of the set of modems to each base station of a set of base stations 1004. For example, the MC-CM 1002 allocates the subset of modems associated with the UE_IDs 0101, 0201, 0301, 0401, 0601, 0701, 0801, and 1001 to the first eNB 1006 operating on the carrier #1. The allocation allows each base station to communicate with the allocated subset of modems.

When the MC-CM 1002 determines that the set of modems within coverage of the particular area has changed, the MC-CM 1002 may reallocate the subsets of the set of modems to each base station. For example, if flight 12 enters into the coverage area of the eNBs 1004, the MC-CM 1002 may reallocate the modems to each of the eNBs 1004 so that some of the eNBs 1004 communicate with the modems on the flight 12.

The MC-CM 1002 may receive information indicating a first subset of modems within coverage of the particular area. The MC-CM 1002 may receive the information from the base stations 1004 providing service to the particular area. The first subset of modems may include the modems that are in an RRC connection state and/or trying to connect to the base stations 1004. The MC-CM 1002 may infer the presence of a second subset of modems within coverage of the particular area based on the received information. For example, the MC-CM 1002 may receive information indicating the presence of the modem associated with the UE ID 0101 and infer the presence of the modems associated with the UE IDs 0102, 0103, 0104, and 0105. The MC-CM 1002 may allocate the modems in the first and second subsets of modems. Further, the MC-CM 1002 may determine a third subset of modems that will be handed over to one or more target base stations of the set of base stations. For example, the third subset of modems may include the modems on the flight 12 with UE IDs 1201, 1202, 1203, 1204, and 1205. The MC-CM 1002 may receive information indicating the third subset of modems from the one or more target base stations. The MC-CM 1002 may allocate modems in the first, second, and third subsets of modems.

Accordingly, the MC-CM 1002 may update the schedule in the event of handover, during which the aircraft may still be in the old cell (i.e., not under the coverage of current cell), but the target eNB is notified in advance. The target eNB may inform the MC-CM 1002 about the handover so that the reallocation will be triggered in preparation for the new aircraft. Further, the MC-CM 1002 may know the association between modem and aircraft so that when one modem enters/tries to handover to the cell, the MC-CM 1002 knows that other modems on the aircraft will be moving to the cell as well. For example, if the modem with UE ID 1202 enters/tries to handover to the cell, the MC-CM 1002 may determine that the modems associated with UE IDs 1201, 1203, 1204, and 1205 on the aircraft will be moving to the cell as well.

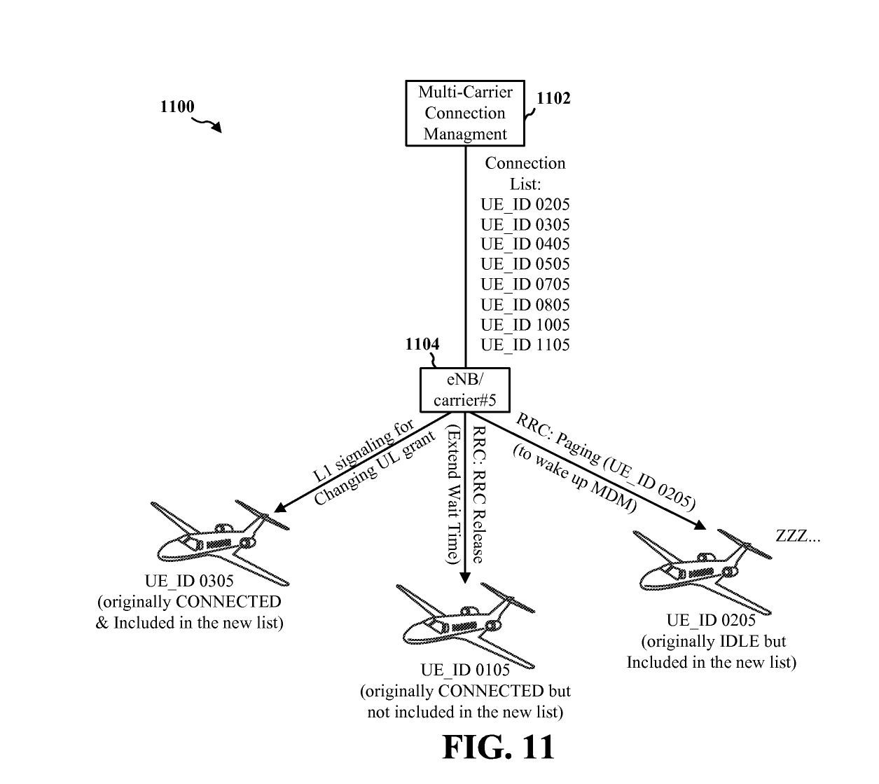

FIG. 11 is a diagram 1100 illustrating an operation of a connection management entity 1102 and an associated eNB 1104. An eNB 1104 may assign a receive (Rx) beam, UL subband, subframes, etc., to the flights/MDMs based on an interference impact. The eNB 1104 may consider UL and DL together in resource allocation for proper HARQ ACK/NAK operation. As discussed supra, the eNB 1104 may receive a list of allocated MDMs. The eNB 1104 may release connections to the MDMs that are not on the list (not allocated). The eNB 1104 may configure/set an extended wait time in the release message to keep an MDM in an idle state from attempting to reconnect to the eNB 1104. The eNB 1104 may change the subband and subframe allocation on UL for existing connected MDMs on the list (that are currently allocated) to avoid interference among connected flights as needed. The eNB 1104 may wake up the idle MDMs on the list via paging.

Specifically, a base station, such as the eNB 1104, determines a set of modems within coverage of the base station. The set of modems is associated with one carrier of a plurality of carriers. The base station operates on the one carrier. Each modem in the set of modems is associated with a different aircraft. The base station sends information indicating the set of modems. The base station receives an allocation of a second set of modems in response to the sent information. The allocation allows the base station to communicate with the allocated second set of modems. For example, referring to FIG. 11, the eNB 1104 determines a set of modems associated with one or more of the UE_IDs 0105, 0205, 0305, 0405, 0505, 0605, 0705, 0805, 0905, 1005, and 1105 are within coverage of the eNB 1104. The set of modems is associated with carrier #5 of a plurality of carriers. The eNB 1104 operates on the carrier #5. Each modem in the set of modems is associated with a different aircraft (flights 1 through 11). The eNB 1104 sends information indicating the set of modems to the MC-CM 1102. For example, the eNB 1104 may send information indicating the set of modems 0105, 0305, 0405, 0905, and 1105. The eNB 1104 may not know all of the modems within coverage of the base station in the cell if they are not all in an RRC connected state. The eNB 1104 may just report the list of modems that are connected/trying to connect to the eNB 1104. The MC-CM 1102 may know the association between modem and aircraft so that the MC-CM 1102 can infer the presence of other modems of the aircraft. Further, the MC-CM 1102 may receive information from other eNBs reporting on other modems, and infer the presence of modems based on all of the information that the MC-CM 1102 receives. The eNB 1104 then receives an allocation of a second set of modems in response to the sent information. The second set of modems includes the modems associated with the UE IDs 0205, 0305, 0405, 0505, 0705, 0805, 1005, and 1105. The eNB 1104 generates a new connection list and adds the second set of modems to the connection list. The allocation allows the eNB 1104 to communicate with the allocated second set of modems. As such, the eNB 1104 is allowed to communicate with the modems for carrier #5 on the flights 2, 3, 4, 5, 7, 8, 10, and 11.

A base station, such as the eNB 1104, communicates with an initial set of modems in an RRC connected state. The base station compares the initial set of modems to the allocated second set of modems. The base station determines an RRC state for a modem in at least one of the initial set of modems or the allocated second set of modems based on the comparison. For example, assume the modem associated with the UE_ID 0305 was in previous communication (i.e., was in an RRC connected state) with the eNB 1104. As such, the modem associated with the UE_ID 0305 is in an initial set of modems. Because the modem associated with the UE_ID 0305 is also allocated to the eNB 1104 (the modem is included in both the initial set of modems and the allocated second set of modems), the eNB 1104 may maintain the RRC connected state with the modem. For another example, assume the modem associated with the UE_ID 0105 was in previous communication with the eNB 1104. As such, the modem associated with the UE_ID 0105 is in an initial set of modems. Because the modem associated with the UE_ID 0105 is not allocated to the eNB 1104 (the modem is included in the initial set of modems and is unincluded in the allocated second set of modems), the eNB 1104 may release an RRC connection with the modem to enter into an RRC idle state from the RRC connected state. The eNB 1104 may also configure a timer in the modem to prevent the modem from attempting to move (preventing the modem from performing a RACH procedure) from the RRC idle state to the RRC connected state for a particular time period. For another example, assume the modem associated with the UE_ID 0205 was not in previous communication (i.e., was in an RRC idle state) with the eNB 1104. As such, the modem associated with the UE_ID 0205 is not in an initial set of modems. Because the modem associated with the UE_ID 0205 is allocated to the eNB 1104 (the modem is included in the allocated second set of modems and is unincluded in the initial set of modems), the eNB 1104 may page the modem to enter into the RRC connected state (by performing a RACH procedure) from an RRC idle state.

To avoid DL data from getting stalled at the S-GW, the MC-CM 1102 may notify the NW IP aggregator to suspend DL transmissions over the PDN connection on the carriers not assigned to the aircraft. The MC-CM 1102 may notify the NW IP aggregator to resume DL transmission as needed when the aircraft becomes connected over a carrier. If an MDM on an aircraft attempts to attach to the network on a carrier, the MC-CM 1102 may allocate resources for the MDM to complete the attach procedure even if the MC-CM 1102 decides to place the MDM in an idle state after the attach for fair resource sharing across the five carriers. The MC-CM 1102 is a logical entity. The MC-CM 1102 may reside on the MME or may be standalone equipment over the five eNBs.

While reference is made supra to the MC-CM 1102 coordinating with base stations to allocate modems within aircraft to different base stations, the MC-CM 1102 may coordinate with cells to allocate modems within aircraft to different cells. Each cell may be a base station or may be one of a plurality of cells of a base station. For example, a base station may include a plurality of cells, each associated with a different carrier frequency. The MC-CM 1102 may coordinate with the cells to allocate modems within aircraft to each of the cells.

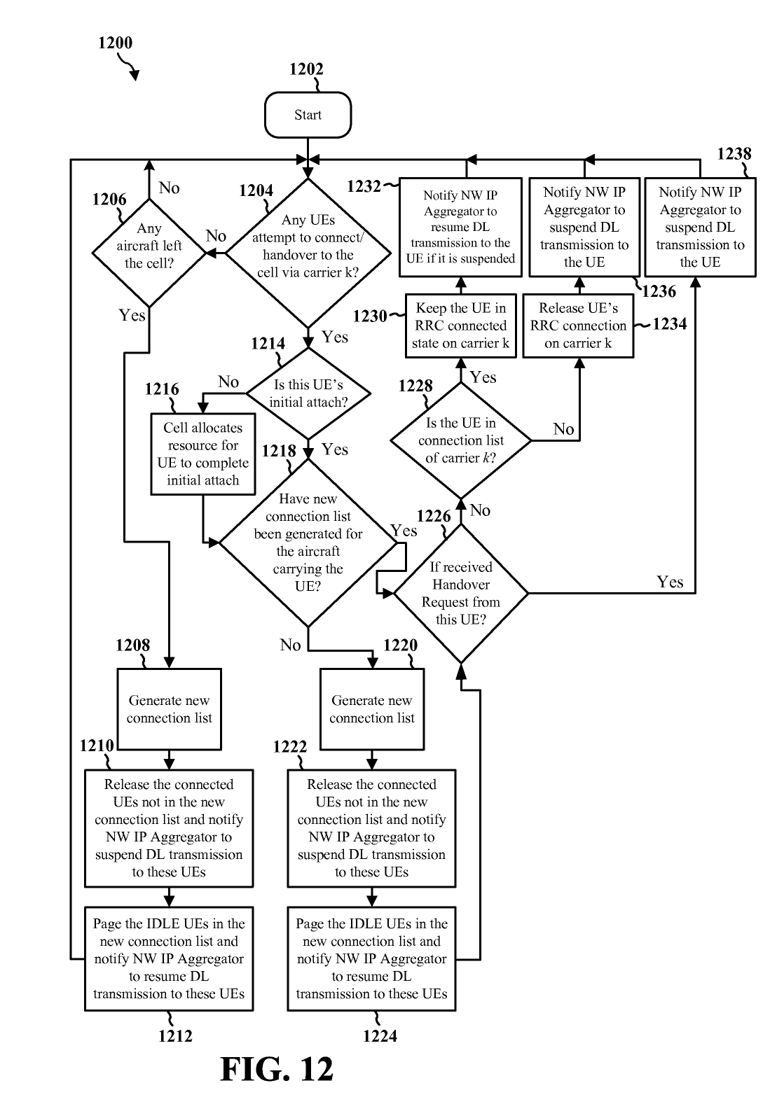

FIG. 12 is a flow chart 1200 illustrating exemplary methods for multi-carrier connection management for bandwidth aggregation. The multi-carrier connection management for bandwidth aggregation may be over LTE bearers. The flow chart starts at step 1202. At step 1204, a cell (e.g., an eNB or a cell within an eNB) operating on carrier k determines whether any UEs (MDMs) attempted to connect/handover to the cell via carrier k. If no at step 1204, then at step 1206, the cell determines if any aircraft has left the cell. If no at step 1206, flow returns to step 1202. If yes at step 1206, then at step 1208, the cell generates a new connection list. At step 1210, the cell releases the connected UEs not in the new connection list and notifies the NW IP Aggregator to suspend DL transmission to the released UEs. At step 1212, the cell pages the idle UEs in the new connection list and notifies the NW IP Aggregator to resume DL transmission to those UEs. Subsequently, flow returns to step 1202.

If at step 1204, a UE has attempted to connect/handover to the cell via carrier k, at step 1214, the cell determines if the attempt to connect/handover is an initial attach to the cell. If no at step 1214, then at step 1216, the cell allocates resources for the UE to complete the initial attach. Subsequent to step 1216 or if yes at step 1214, then at step 1218, the cell determines if a new connection list was generated for the aircraft carrying the UE. If no at step 1218, then at step 1220, the cell generates a new connection list. At step 1222, the cell releases the connected UEs not in the new connection list and notifies the NW IP Aggregator to suspend DL transmission to the released UEs. At step 1224, the cell pages the idle UEs in the new connection list and notifies the NW IP Aggregator to resume DL transmission to those UEs. Subsequent to step 1224 or if at step 1218 the cell determines that a new connection list was generated for the aircraft carrying the UE, at step 1226, the cell determines if a handover request was received from the UE. If yes at step 1226, then at step 1238, the cell notifies the NW IP Aggregator to suspend DL transmission to the UE. If no at step 1226, then at step 1228, the cell determines whether the UE is in the connection list of carrier k. If no at step 1228, then at step 1234, the cell releases the RRC connection on carrier k for the UE. Subsequently, at step 1236, the cell notifies the NW IP Aggregator to suspend DL transmission to the UE. However, if yes at step 1228, then at step 1230, the cell keeps the UE in an RRC connected state on carrier k. Subsequently, at step 1232, the cell notifies the NW IP Aggregator to resume DL transmission to the UE if the DL transmission is suspended. After steps 1238, 1236, and 1232, flow returns to step 1202.

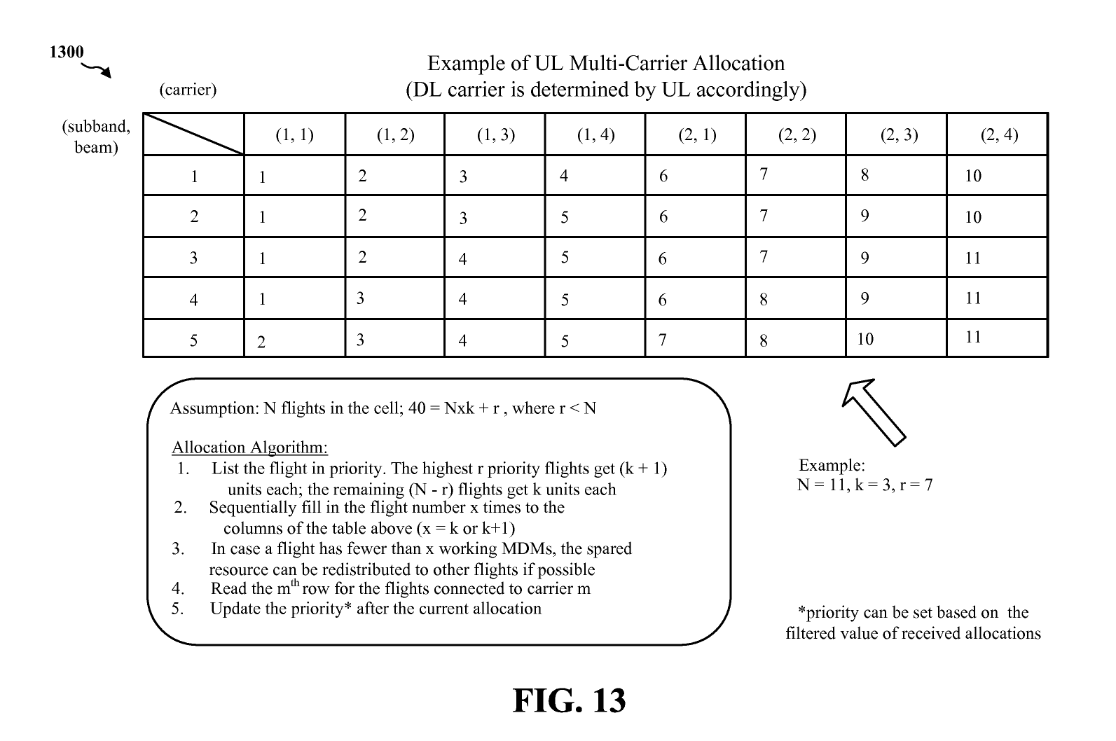

FIG. 13 is a diagram 1300 illustrating a first exemplary allocation method. Assuming there are n carriers with s subbands per carrier and the eNBs can provide b beams for each subband, n*s*b separate resources may be allocated to the flights/aircraft within coverage of the eNBs. As shown in FIG. 13, there are five carriers, two subbands per carrier, and four beams for each subband, providing 40 resources for allocation to the flights/aircraft within the coverage of the eNBs. As shown in FIG. 13, the MC-CM may allocate the resources approximately evenly by providing k resources per flight/aircraft for N-r flights/aircraft, and k+1 resources per flight/aircraft for r flights/aircraft, where 40=N*k+r. In FIG. 13, N=11, k=3, and r=7. Specifically, in the allocation algorithm, in (1), the MC-CM lists the flights in order of priority. The highest r priority flights are allocated (k+1) resources/units each. The remaining (N−r) flights are allocated k resources/units each. In (2), the MC-CM sequentially fills in the flight number x times to the columns of the table above (x=k or k+1). In (3), in case a flight has fewer than x working MDMs, the MC-CM redistributes the spared resource to other flights if possible. In (4), the MC-CM reads the m^{th} row for the flights connected to carrier m. In (5), the MC-CM updates the priority after the current allocation.

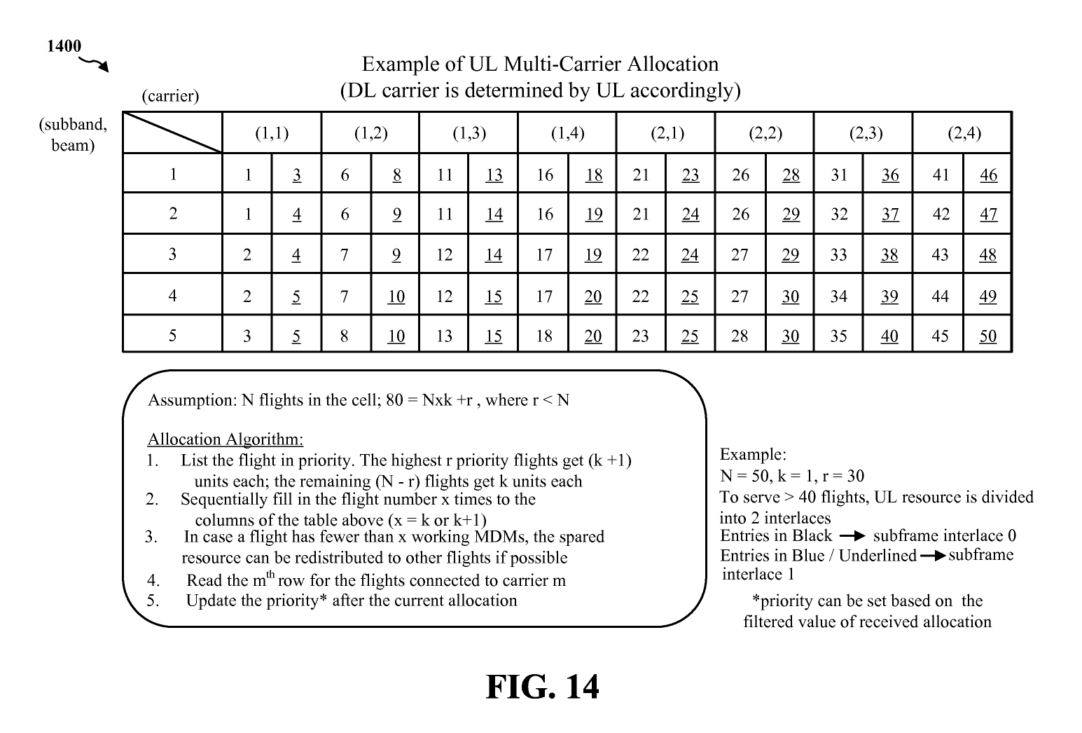

FIG. 14 is a diagram 1400 illustrating a second exemplary allocation method. In FIG. 14, the resources are split into multiple subframe interlaces. Assuming there are two UL subframes per radio frame (using TDD), one subframe may serve for interlace 0 and the other subframe may serve for interlace 1. Accordingly, the number of resources for allocation to flights/aircraft is equal to n*s*b*i, where i is the number of interlaces. As shown in FIG. 14, there are five carriers, two subbands per carrier, four beams for each subband, and two interlaces, providing 80 resources for allocation to the flights/aircraft within the coverage of the eNBs. The resources may be split in the same manner as discussed with respect to FIG. 13.

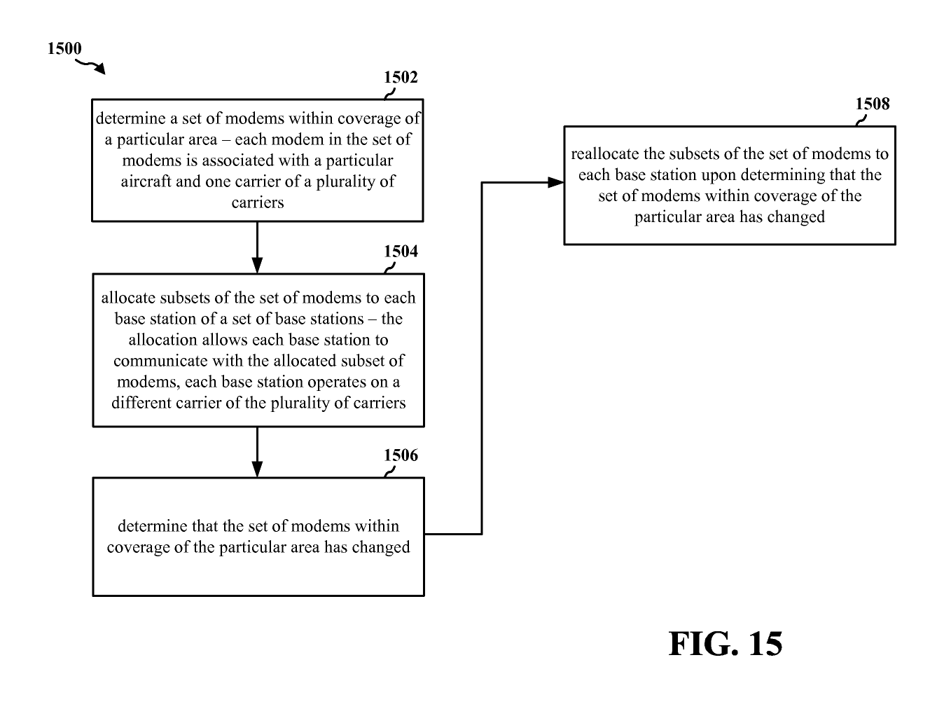

FIG. 15 is a flow chart 1500 of a first exemplary method of a connection management entity. As shown in FIG. 15, at step 1502, the connection management entity determines a set of modems within coverage of a particular area. Each modem in the set of modems is associated with a particular aircraft and one carrier of a plurality of carriers. For example, at step 1502, an MC-CM may determine that a set of modems associated with the UE IDs XYZW for XY (carriers) equal to 1, 2, . . . , 5 and ZW (aircraft) equal to 1, 2, . . . , 11 are within coverage of a particular area. At step 1504, the connection management entity allocates subsets of the set of modems to each cell of a set of cells. The allocation allows each cell to communicate with the allocated subset of modems. Each cell operates on a different carrier of the plurality of carriers. For example, referring to FIG. 10, at step 1504, the MC-CM may allocate MDMs with the UE IDs 0101, 0201, 0301, 0401, 0601, 0701, 0801, and 1001 to a first cell operating on a first carrier; MDMs with the UE IDs 0102, 0202, 0302, 0502, 0602, 0702, 0902, 1002 to a second cell operating on a second carrier; MDMs with the UE IDs 0103, 0203, 0403, 0503, 0603, 0703, 0903, and 1103 to a third cell operating on a third carrier; MDMs with the UE IDs 0104, 0304, 0404, 0504, 0604, 0804, 0904, and 1104 to a fourth cell operating on a fourth carrier; and MDMs with the UE IDs 0205, 0305, 0405, 0505, 0705, 0805, 1005, and 1105 to a fifth cell operating on a fifth carrier. At step 1506, the connection management entity determines that the set of modems within coverage of the particular area has changed. For example, the MC-CM may determine that flight/aircraft 11 is no longer within coverage of the particular area and/or that flight/aircraft 12 is now within coverage of the particular area. At step 1508, the connection management entity reallocates the subsets of the set of modems to each cell upon determining that the set of modems within coverage of the particular area has changed. For example, the MC-CM may reallocate the subsets of the set of modems to exclude MDMs of flight/aircraft 11 and/or to include MDMs of flight/aircraft 12.

The connection management entity may receive information indicating a first subset of modems within coverage of the particular area, and infer the presence of a second subset of modems within coverage of the particular area based on the received information. For example, the connection management entity may receive information indicating the presence of the modem associated with the UE ID XYZW (flight XY and carrier ZW) and infer the presence of all of the modems on the flight/aircraft XY. At step 1502, the connection management entity may determine the set of modems to include both the first subset of modems with a detected presence within the particular area and the second subset of modems with an inferred presence within the particular area. The connection management entity may determine a third subset of modems that will be handed over to one or more target cells of the set of cells. The connection management entity may receive information from the one or more target cells indicating the third subset of modems. The connection management entity may then determine the set of modems to further include the third subset of modems so that the allocation includes modems that will soon be within coverage of the particular area. At step 1504, each modem in the subsets of the set of modems may be allocated to at least one of a subband or a beam of the cell (see FIG. 13). Alternatively or in addition, at step 1504, each modem in the subsets of the set of modems may be allocated an interlace of a plurality of interlaces within at least one resource (see FIG. 14).

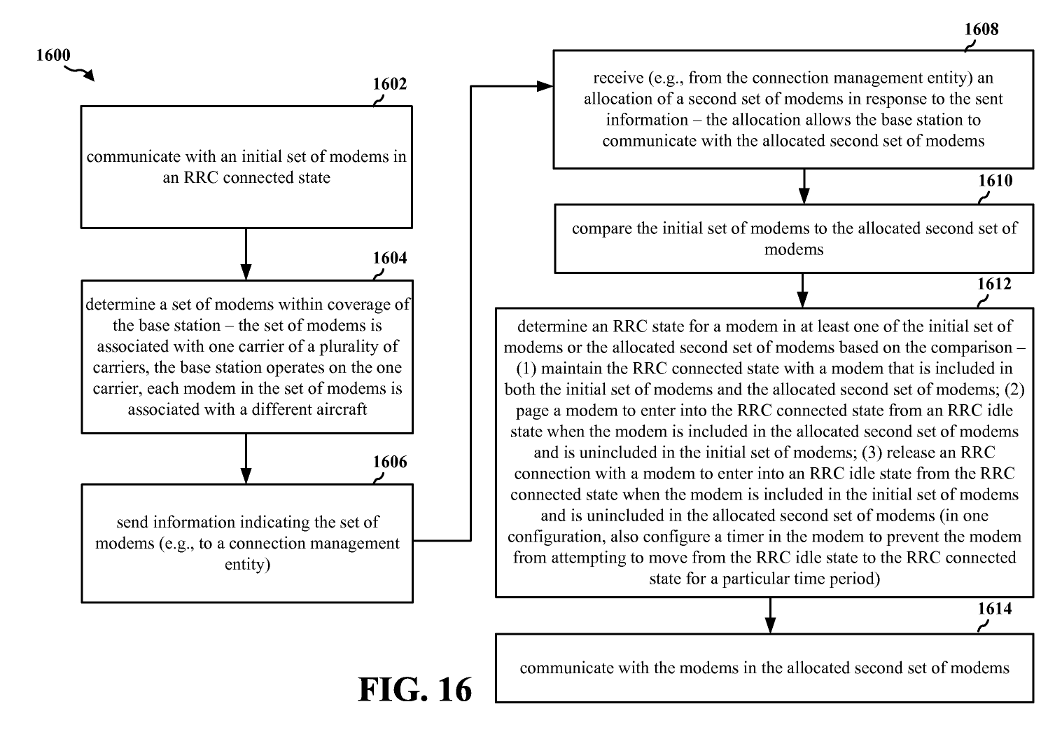

FIG. 16 is a flow chart 1600 of a second exemplary method of a cell. As shown in FIG. 16, at step 1602, the cell communicates with an initial set of modems in an RRC connected state. At step 1604, the cell determines a set of modems within coverage of the cell. The set of modems is associated with one carrier of a plurality of carriers. The cell operates on the one carrier. Each modem in the set of modems is associated with a different aircraft. At step 1606, the cell sends information indicating the set of modems (e.g., to a connection management entity, which may be a standalone entity or part of the MME). At step 1608, the cell receives (e.g., from the connection management entity) an allocation of a second set modems in response to the sent information. The allocation allows the cell to communicate with the allocated second set of modems. At step 1608, the cell may also receive information indicating at least one of a subband, a beam, or a resource interlace to use in association with each modem in the second set of modems. At step 1610, the cell compares the initial set of modems to the allocated second set of modems. At step 1612, the cell determines an RRC state for a modem in at least one of the initial set of modems or the allocated second set of modems based on the comparison. At step 1612, the cell may maintain the RRC connected state with a modem that is included in both the initial set of modems and the allocated second set of modems. At step 1612, the cell may page a modem to enter into the RRC connected state from an RRC idle state when the modem is included in the allocated second set of modems and is unincluded in the initial set of modems. At step 1612, the cell may release an RRC connection with a modem to enter into an RRC idle state from the RRC connected state when the modem is included in the initial set of modems and is unincluded in the allocated second set of modems. In addition, the cell may configure a timer in the modem to prevent the modem from attempting to move from the RRC idle state to the RRC connected state for a particular time period. At step 1614, the cell communicates with the modems in the allocated second set of modems. If at step 1608, the cell received information indicating at least one of a subband, a beam, or a resource interlace to use in association with each modem in the second set of modems, at step 1614, the cell may communicate with each modem in the second set of modems based on the information indicating the at least one of the subband, the beam, or the resource interlace.

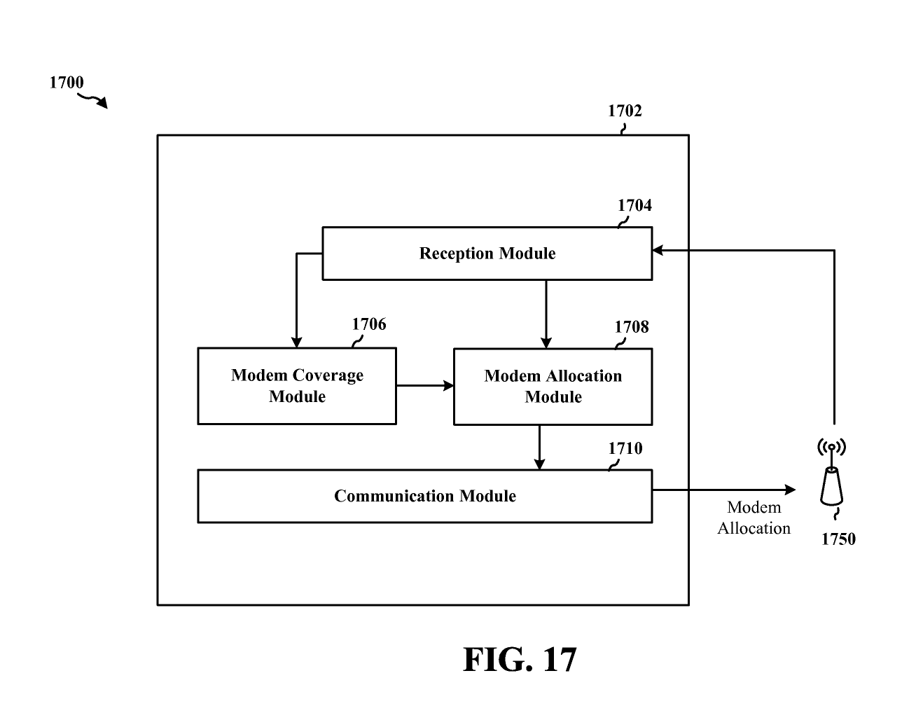

FIG. 17 is a conceptual data flow diagram 1700 illustrating the data flow between different modules/means/components in an exemplary apparatus 1702. The apparatus may be a connection management entity (e.g., the MC-CM 902, 1002, 1102). The apparatus includes a modem coverage module 1706 that is configured to determine a set of modems within coverage of a particular area. Each modem in the set of modems is associated with a particular aircraft and one carrier of a plurality of carriers. The apparatus further includes a modem allocation module 1708 that is configured to allocate subsets of the set of modems to each cell of a set of cells, including the cell 1750. The allocation allows each cell to communicate with the allocated subset of modems. Each cell operates on a different carrier of the plurality of carriers.

The modem coverage module 1706 may be configured to determine that the set of modems within coverage of the particular area has changed. The modem allocation module 1708 may be configured to reallocate the subsets of the set of modems to each cell upon determining that the set of modems within coverage of the particular area has changed. The apparatus may further include a reception module 1704 that is configured to receive information indicating a first subset of modems within coverage of the particular area. The modem coverage module 1706 may be configured to infer the presence of a second subset of modems within coverage of the particular area based on the received information. The determined set of modems may include the first subset of modems and the second subset of modems. The modem coverage module 1706 may be configured to determine a third subset of modems that will be handed over to one or more cells of the set of cells. The determined set of modems may further include the third subset of modems. The apparatus may further include a communication module 1710 that is configured to send information to the cells, include the cell 1750, indicating the allocated modems for the cell. The modem allocation module 1708 may be configured to allocate each modem in the subsets of the set of modems to at least one of a subband or a beam of the cell. The modem allocation module 1708 may be configured to allocate each modem in the subsets of the set of modems an interlace of a plurality of interlaces within at least one resource.

The apparatus may include additional modules that perform each of the steps of the algorithm in the aforementioned flow chart of FIG. 15. As such, each step in the aforementioned flow chart of FIG. 15 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

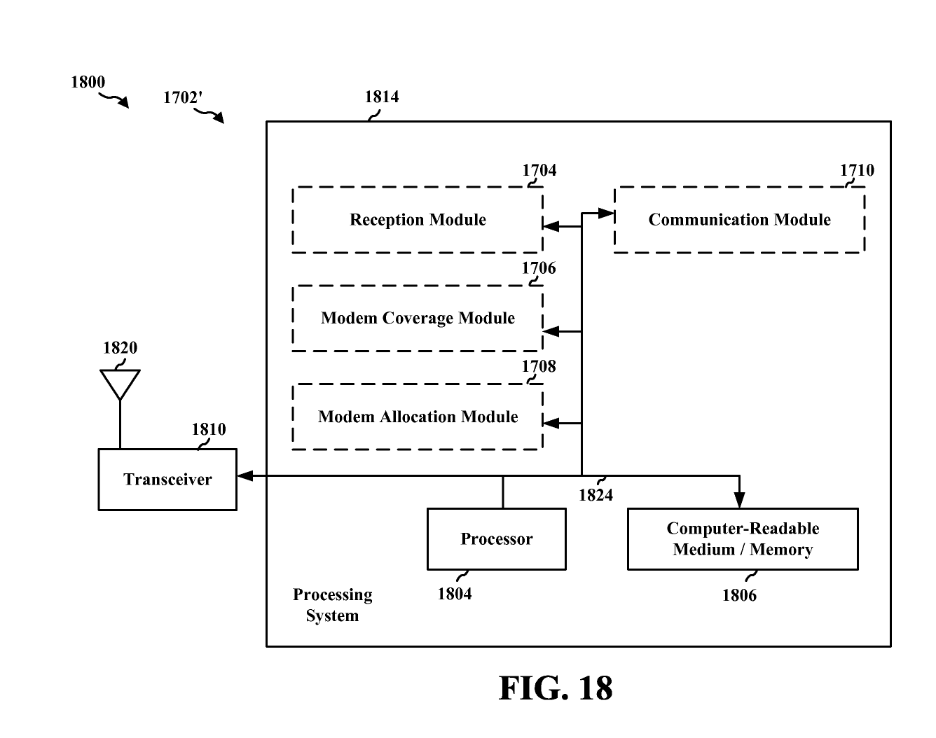

FIG. 18 is a diagram 1800 illustrating an example of a hardware implementation for an apparatus 1702′ employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware modules, represented by the processor 1804, the modules 1704, 1706, 1708, and 1710 and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814. In addition, the transceiver 1810 receives information from the processing system 1814, and based on the received information, generates a signal to be applied to the one or more antennas 1820. The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system further includes at least one of the modules 1704, 1706, 1708, and 1710. The modules may be software modules running in the processor 1804, resident/stored in the computer readable medium/memory 1806, one or more hardware modules coupled to the processor 1804, or some combination thereof.

In one configuration, the apparatus 1702/1702′ for wireless communication may be a connection management entity and may include means for determining a set of modems within coverage of a particular area. Each modem in the set of modems may be associated with a particular aircraft and one carrier of a plurality of carriers. The apparatus may further include means for allocating subsets of the set of modems to each cell of a set of cells. The allocation may allow each cell to communicate with the allocated subset of modems. Each cell may operate on a different carrier of the plurality of carriers. The apparatus may further include means for determining that the set of modems within coverage of the particular area has changed, and means for reallocating the subsets of the set of modems to each cell upon determining that the set of modems within coverage of the particular area has changed. The apparatus may further include means for receiving information indicating a first subset of modems within coverage of the particular area, and means for inferring the presence of a second subset of modems within coverage of the particular area based on the received information. The determined set of modems may include the first subset of modems and the second subset of modems. The apparatus may further include means for determining a third subset of modems that will be handed over to one or more cells of the set of cells. The determined set of modems may further include the third subset of modems. The aforementioned means may be one or more of the aforementioned modules of the apparatus 1702 and/or the processing system 1814 of the apparatus 1702′ configured to perform the functions recited by the aforementioned means.

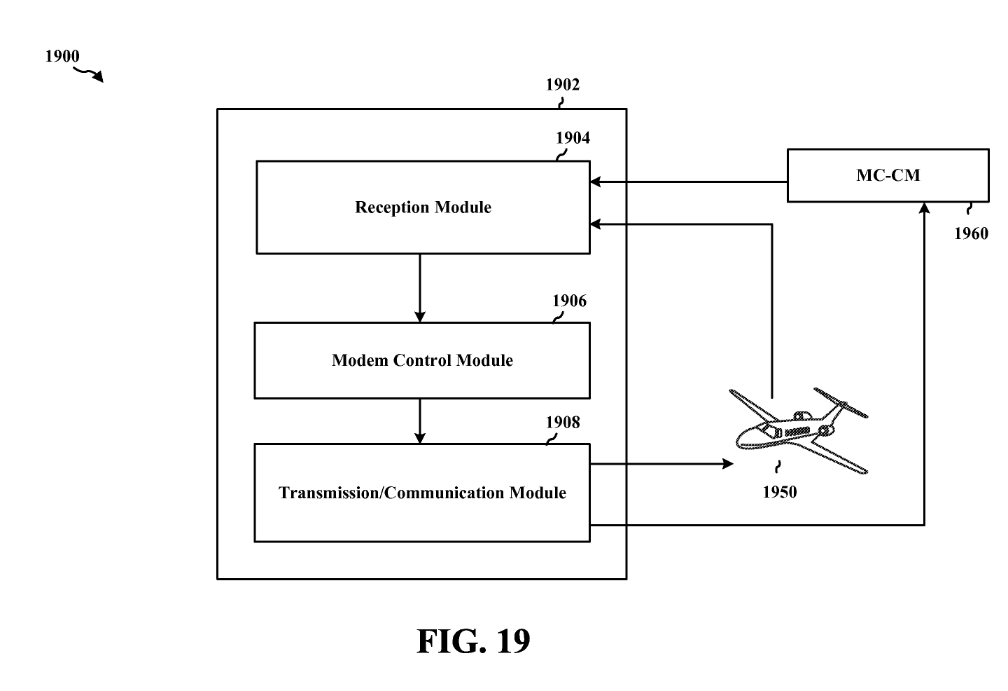

FIG. 19 is a conceptual data flow diagram 1900 illustrating the data flow between different modules/means/components in an exemplary apparatus 1902. The apparatus may be a cell (e.g., an eNB or a cell within an eNB). The cell includes a modem control module 1906, that with the help of the reception module 1904, is configured to determine a set of modems within coverage of the cell. The set of modems is associated with one carrier of a plurality of carriers. The cell operates on the one carrier. Each modem in the set of modems is associated with a different aircraft. The cell further includes a transmission/communication module 1908 that is configured to send information indicating the set of modems to an MC-CM 1960. The reception module 1904 is configured to receive an allocation of a second set of modems from the MC-CM 1960 in response to the sent information. The second set of modems includes a modem on the aircraft 1950. The allocation allows the cell to communicate with the allocated second set of modems.

The transmission/communication module 1908 may be further configured to communicate with an initial set of modems in an RRC connected state. The modem control module 1906 may be configured to compare the initial set of modems to the allocated second set of modems, and to determine an RRC state for a modem in at least one of the initial set of modems or the allocated second set of modems based on the comparison. The modem control module 1906 may be configured to maintain the RRC connected state with a modem that is included in both the initial set of modems and the allocated second set of modems. The modem control module 1906 may be configured to page a modem to enter into the RRC connected state from an RRC idle state when the modem is included in the allocated second set of modems and is unincluded in the initial set of modems. The modem control module 1906 may be configured to release an RRC connection with a modem to enter into an RRC idle state from the RRC connected state when the modem is included in the initial set of modems and is unincluded in the allocated second set of modems. The modem control module 1906 may be configured to configure a timer in the modem to prevent the modem from attempting to move from the RRC idle state to the RRC connected state for a particular time period. The reception module 1904 may be configured to receive, from the MC-CM 1960, information indicating at least one of a subband, a beam, or a resource interlace to use in association with each modem in the second set of modems. The transmission/communication module 1908 may be configured to communicate with each modem in the second set of modems based on the information indicating the at least one of the subband, the beam, or the resource interlace.

The apparatus may include additional modules that perform each of the steps of the algorithm in the aforementioned flow chart of FIG. 16. As such, each step in the aforementioned flow chart of FIG. 16 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

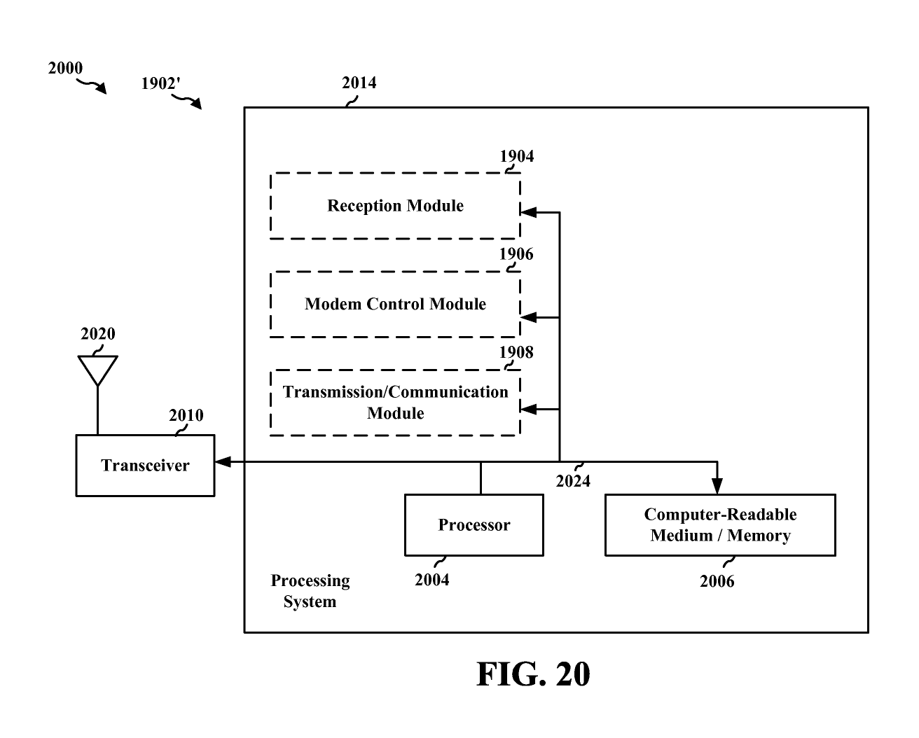

FIG. 20 is a diagram 2000 illustrating an example of a hardware implementation for an apparatus 1902′ employing a processing system 2014. The processing system 2014 may be implemented with a bus architecture, represented generally by the bus 2024. The bus 2024 may include any number of interconnecting buses and bridges depending on the specific application of the processing system 2014 and the overall design constraints. The bus 2024 links together various circuits including one or more processors and/or hardware modules, represented by the processor 2004, the modules 1904, 1906, and 1908, and the computer-readable medium/memory 2006. The bus 2024 may also link various other circuits such as timing sources, peripherals, voltage regulators, and power management circuits, which are well known in the art, and therefore, will not be described any further.

The processing system 2014 may be coupled to a transceiver 2010. The transceiver 2010 is coupled to one or more antennas 2020. The transceiver 2010 provides a means for communicating with various other apparatus over a transmission medium. The transceiver 2010 receives a signal from the one or more antennas 2020, extracts information from the received signal, and provides the extracted information to the processing system 2014. In addition, the transceiver 2010 receives information from the processing system 2014, and based on the received information, generates a signal to be applied to the one or more antennas 2020. The processing system 2014 includes a processor 2004 coupled to a computer-readable medium/memory 2006. The processor 2004 is responsible for general processing, including the execution of software stored on the computer-readable medium/memory 2006. The software, when executed by the processor 2004, causes the processing system 2014 to perform the various functions described supra for any particular apparatus. The computer-readable medium/memory 2006 may also be used for storing data that is manipulated by the processor 2004 when executing software. The processing system further includes at least one of the modules 1904, 1906, and 1908. The modules may be software modules running in the processor 2004, resident/stored in the computer readable medium/memory 2006, one or more hardware modules coupled to the processor 2004, or some combination thereof. The processing system 2014 may be a component of the eNB 610 and may include the memory 676 and/or at least one of the TX processor 616, the RX processor 670, and the controller/processor 675.

In one configuration, the apparatus 1902/1902′ for wireless communication is a cell and includes means for determining a set of modems within coverage of the cell. The set of modems is associated with one carrier of a plurality of carriers. The cell operates on the one carrier. Each modem in the set of modems is associated with a different aircraft. The cell further includes means for sending information indicating the set of modems. The cell further includes means for receiving an allocation of a second set modems in response to the sent information. The allocation allows the cell to communicate with the allocated second set of modems. The cell may further include means for communicating with an initial set of modems in an RRC connected state, means for comparing the initial set of modems to the allocated second set of modems, and means for determining an RRC state for a modem in at least one of the initial set of modems or the allocated second set of modems based on the comparison. The cell may further include means for maintaining the RRC connected state with a modem that is included in both the initial set of modems and the allocated second set of modems. The cell may further include means for paging a modem to enter into the RRC connected state from an RRC idle state when the modem is included in the allocated second set of modems and is unincluded in the initial set of modems. The cell may further include means for releasing an RRC connection with a modem to enter into an RRC idle state from the RRC connected state when the modem is included in the initial set of modems and is unincluded in the allocated second set of modems. The cell may further include means for configuring a timer in the modem to prevent the modem from attempting to move from the RRC idle state to the RRC connected state for a particular time period. The cell may further include means for receiving information indicating at least one of a subband, a beam, or a resource interlace to use in association with each modem in the second set of modems. The cell may further include means for communicating with each modem in the second set of modems based on the information indicating the at least one of the subband, the beam, or the resource interlace. The aforementioned means may be one or more of the aforementioned modules of the apparatus 1902 and/or the processing system 2014 of the apparatus 1902′ configured to perform the functions recited by the aforementioned means. As described supra, the processing system 2014 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of a connection management entity, comprising:
determining a set of modems within coverage of a particular area, each modem in the set of modems being associated with a particular aircraft and one carrier of a plurality of carriers; and
allocating subsets of the set of modems to each cell of a set of cells, the allocation allowing each cell to communicate with the allocated subset of modems, each cell operating on a different carrier of the plurality of carriers.

2. The method of claim 1, further comprising:
determining that the set of modems within coverage of the particular area has changed; and
reallocating the subsets of the set of modems to each cell upon determining that the set of modems within coverage of the particular area has changed.

3. The method of claim 1, further comprising:
receiving information indicating a first subset of modems within coverage of the particular area; and
inferring the presence of a second subset of modems within coverage of the particular area based on the received information,
wherein the determined set of modems includes the first subset of modems and the second subset of modems.

4. The method of claim 3, further comprising determining a third subset of modems that will be handed over to one or more cells of the set of cells, wherein the determined set of modems further includes the third subset of modems.

5. The method of claim 1, wherein each modem in the subsets of the set of modems is allocated to at least one of a subband or a beam of the cell.

6. The method of claim 1, wherein each modem in the subsets of the set of modems is allocated an interlace of a plurality of interlaces within at least one resource.

7. A method of wireless communication of a cell, comprising:
determining a set of modems within coverage of the cell, the set of modems being associated with one carrier of a plurality of carriers, the cell operating on the one carrier, each modem in the set of modems being associated with a different aircraft;
sending information indicating the set of modems; and
receiving an allocation of a second set of modems in response to the sent information, the allocation allowing the cell to communicate with the allocated second set of modems.

8. The method of claim 7, further comprising:
communicating with an initial set of modems in a radio resource control (RRC) connected state;
comparing the initial set of modems to the allocated second set of modems; and
determining an RRC state for a modem in at least one of the initial set of modems or the allocated second set of modems based on the comparison.

9. The method of claim 8, further comprising maintaining the RRC connected state with a modem that is included in both the initial set of modems and the allocated second set of modems.

10. The method of claim 8, further comprising paging a modem to enter into the RRC connected state from an RRC idle state when the modem is included in the allocated second set of modems and is unincluded in the initial set of modems.

11. The method of claim 8, further comprising releasing an RRC connection with a modem to enter into an RRC idle state from the RRC connected state when the modem is included in the initial set of modems and is unincluded in the allocated second set of modems.

12. The method of claim 11, further comprising configuring a timer in the modem to prevent the modem from attempting to move from the RRC idle state to the RRC connected state for a particular time period.

13. The method of claim 7, further comprising receiving information indicating at least one of a subband, a beam, or a resource interlace to use in association with each modem in the second set of modems.

14. The method of claim 13, further comprising communicating with each modem in the second set of modems based on the information indicating the at least one of the subband, the beam, or the resource interlace.

15. A connection management entity apparatus, comprising:
means for determining a set of modems within coverage of a particular area, each modem in the set of modems being associated with a particular aircraft and one carrier of a plurality of carriers; and
means for allocating subsets of the set of modems to each cell of a set of cells, the allocation allowing each cell to communicate with the allocated subset of modems, each cell operating on a different carrier of the plurality of carriers.

16. The apparatus of claim 15, further comprising:
means for determining that the set of modems within coverage of the particular area has changed; and
means for reallocating the subsets of the set of modems to each cell upon determining that the set of modems within coverage of the particular area has changed.

17. The apparatus of claim 15, further comprising:
means for receiving information indicating a first subset of modems within coverage of the particular area; and
means for inferring the presence of a second subset of modems within coverage of the particular area based on the received information,
wherein the determined set of modems includes the first subset of modems and the second subset of modems.

18. The apparatus of claim 17, further comprising means for determining a third subset of modems that will be handed over to one or more cells of the set of cells, wherein the determined set of modems further includes the third subset of modems.

19. The apparatus of claim 15, wherein each modem in the subsets of the set of modems is allocated to at least one of a subband or a beam of the cell.

20. The apparatus of claim 15, wherein each modem in the subsets of the set of modems is allocated an interlace of a plurality of interlaces within at least one resource.

21. An apparatus for wireless communication, the apparatus being a cell, comprising:
means for determining a set of modems within coverage of the cell, the set of modems being associated with one carrier of a plurality of carriers, the cell operating on the one carrier, each modem in the set of modems being associated with a different aircraft;
means for sending information indicating the set of modems; and
means for receiving an allocation of a second set modems in response to the sent information, the allocation allowing the cell to communicate with the allocated second set of modems.

22. The apparatus of claim 21, further comprising:
means for communicating with an initial set of modems in a radio resource control (RRC) connected state;
means for comparing the initial set of modems to the allocated second set of modems; and
means for determining an RRC state for a modem in at least one of the initial set of modems or the allocated second set of modems based on the comparison.

23. The apparatus of claim 22, further comprising means for maintaining the RRC connected state with a modem that is included in both the initial set of modems and the allocated second set of modems.

24. The apparatus of claim 22, further comprising means for paging a modem to enter into the RRC connected state from an RRC idle state when the modem is included in the allocated second set of modems and is unincluded in the initial set of modems.

25. The apparatus of claim 22, further comprising means for releasing an RRC connection with a modem to enter into an RRC idle state from the RRC connected state when the modem is included in the initial set of modems and is unincluded in the allocated second set of modems.

26. The apparatus of claim 25, further comprising means for configuring a timer in the modem to prevent the modem from attempting to move from the RRC idle state to the RRC connected state for a particular time period.

27. The apparatus of claim 22, further comprising means for receiving information indicating at least one of a subband, a beam, or a resource interlace to use in association with each modem in the second set of modems.

28. The apparatus of claim 27, further comprising means for communicating with each modem in the second set of modems based on the information indicating the at least one of the subband, the beam, or the resource interlace.

29. A connection management entity apparatus, comprising:
a memory; and
at least one processor coupled to the memory and configured to:
determine a set of modems within coverage of a particular area, each modem in the set of modems being associated with a particular aircraft and one carrier of a plurality of carriers; and
allocate subsets of the set of modems to each cell of a set of cells, the allocation allowing each cell to communicate with the allocated subset of modems, each cell operating on a different carrier of the plurality of carriers.

30. The apparatus of claim 29, wherein the at least one processor is further configured to:
determine that the set of modems within coverage of the particular area has changed; and
reallocate the subsets of the set of modems to each cell upon determining that the set of modems within coverage of the particular area has changed.

31. The apparatus of claim 29, wherein the at least one processor is further configured to:
receiving information indicating a first subset of modems within coverage of the particular area; and
inferring the presence of a second subset of modems within coverage of the particular area based on the received information,
wherein the determined set of modems includes the first subset of modems and the second subset of modems.

32. The apparatus of claim 31, wherein the at least one processor is further configured to determine a third subset of modems that will be handed over to one or more cells of the set of cells, wherein the determined set of modems further includes the third subset of modems.

33. The apparatus of claim 29, wherein each modem in the subsets of the set of modems is allocated to at least one of a subband or a beam of the cell.

34. The apparatus of claim 29, wherein each modem in the subsets of the set of modems is allocated an interlace of a plurality of interlaces within at least one resource.

35. An apparatus for wireless communication, the apparatus being a cell, comprising:
a memory; and
at least one processor coupled to the memory and configured to:
determine a set of modems within coverage of the cell, the set of modems being associated with one carrier of a plurality of carriers, the cell operating on the one carrier, each modem in the set of modems being associated with a different aircraft;
send information indicating the set of modems; and
receive an allocation of a second set of modems in response to the sent information, the allocation allowing the cell to communicate with the allocated second set of modems.

36. The apparatus of claim 35, wherein the at least one processor is further configured to:
communicate with an initial set of modems in a radio resource control (RRC) connected state;
compare the initial set of modems to the allocated second set of modems; and
determine an RRC state for a modem in at least one of the initial set of modems or the allocated second set of modems based on the comparison.

37. The apparatus of claim 36, wherein the at least one processor is further configured to maintain the RRC connected state with a modem that is included in both the initial set of modems and the allocated second set of modems.

38. The apparatus of claim 36, wherein the at least one processor is further configured to page a modem to enter into the RRC connected state from an RRC idle state when the modem is included in the allocated second set of modems and is unincluded in the initial set of modems.

39. The apparatus of claim 36, wherein the at least one processor is further configured to release an RRC connection with a modem to enter into an RRC idle state from the RRC connected state when the modem is included in the initial set of modems and is unincluded in the allocated second set of modems.

40. The apparatus of claim 39, wherein the at least one processor is further configured to configure a timer in the modem to prevent the modem from attempting to move from the RRC idle state to the RRC connected state for a particular time period.

41. The apparatus of claim 35, wherein the at least one processor is further configured to receive information indicating at least one of a subband, a beam, or a resource interlace to use in association with each modem in the second set of modems.

42. The apparatus of claim 41, wherein the at least one processor is further configured to communicate with each modem in the second set of modems based on the information indicating the at least one of the subband, the beam, or the resource interlace.

43. A computer program product stored on a computer-readable medium and comprising code that when executed on at least one processor performs the steps of:
determining a set of modems within coverage of a particular area, each modem in the set of modems being associated with a particular aircraft and one carrier of a plurality of carriers; and
allocating subsets of the set of modems to each cell of a set of cells, the allocation allowing each cell to communicate with the allocated subset of modems, each cell operating on a different carrier of the plurality of carriers.

44. A computer program product stored on a computer-readable medium and comprising code that when executed on at least one processor performs the steps of:
determining a set of modems within coverage of the cell, the set of modems being associated with one carrier of a plurality of carriers, the cell operating on the one carrier, each modem in the set of modems being associated with a different aircraft;
sending information indicating the set of modems; and
receiving an allocation of a second set of modems in response to the sent information, the allocation allowing the cell to communicate with the allocated second set of modems.
